(19) United States
(12) Patent Application Publication
(10) Pub. No.: US 2008/0067016 A1
(43) Pub. Date: Mar. 20, 2008

(54) Disc brake, particularly for a commercial vehicle

(75) Inventors: Wolfgang Pritz, Aldersbach (DE); Robert Trimpe, Wessling (DE); Anton Helf, Soechtetnau (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 11/521,549

(22) Filed: Sep. 15, 2006

(30) Foreign Application Priority Data
Sep. 15, 2006 (DE) 10 2005 044 091.6

(51) Int. Cl. F16D 65/40

(52) U.S. Cl. 188/73.38

(57) ABSTRACT

A disc brake, particularly for a utility vehicle, includes a caliper having a receiving space for an application device. The caliper straddles a brake disc and is movable into an operative connection with brake pads, and is fastened to a brake anchor plate. A holding clip is releasably fastened to the caliper, on which holding clip springs acting upon exterior edges of the brake pad are supported. The holding clip, by way of its end facing away from the receiving space rests in a receiving device of the caliper. For the fastening of the holding clip at its end facing the receiving space on the caliper, a bolt is provided onto which the holding clip is fitted and is held by way of a securing device.

### BACKGROUND AND SUMMARY OF THE INVENTION

The present invention relates to a disc brake, particularly for a commercial vehicle, a caliper with a receiving space for a brake application device. The caliper straddling a brake disc movable into an operative connection with brake pads, and is fastened to a brake anchor plate. A holding clip is releasably fastened to the caliper, on which holding clip springs acting upon exterior edges of the brake pads are supported. The holding clip, by way of its end facing away from the receiving space, rests in a receiving device of the caliper.

A disc brake of this type is known, for example, from German Patent document DE 86 15 015 U1. The holding clip of this disc brake is essentially used for forming an abutment for springs, in this case, leaf springs which elastically brace the brake pads. The holding clip is releasably fastened to the caliper in order to permit a fast mounting, as well as demounting, mainly of the brake pads. The latter takes place in order to permit, for example, an easy access to the brake pads required for a brake pad change.

The fact that the holding clip can be mounted and demounted by means of simple devices also contributes to the above. For this purpose, it is fitted into a recess of the caliper on one side and fixedly connected with the caliper on the other side by means of screwing while bridging an insertion opening for the brake pads.

In this case, the pocket-shaped recess is provided on the side of the caliper which, as it were, forms the exterior side of the brake and which is situated opposite an application device arranged in the caliper, which application device forms the interior side of the brake, thus the side facing the vehicle center. In this case, the pocket-shaped recess may be made by mechanical shaping or may be molded-in by casting when the caliper is produced.

By means of its other end, which faces the application device, the holding clip is screwed to the caliper. However, a correspondingly high-expenditure machining is required for this purpose; that is, a drilling of the core bore and a subsequent thread cutting. Since such disc brakes are produced in large piece numbers, such operations stand in the way of an optimized production, so that the product as a whole can be manufactured only at correspondingly high expenditures.

Furthermore, an arresting of the screw may occur during the operation as a result of weather conditions or because of dirt, which screw will then be difficult to loosen, naturally standing in the way of a desired rapid demounting and thus having a disadvantageous effect on the operating costs.

It is an object of the present invention to further develop a disc brake of the above-mentioned type such that it can be produced at lower cost and the mounting, particularly the demounting of the brake pads, can be carried out in a simpler manner.

This object is achieved by a disc brake having a caliper with a receiving space for a brake application device. The caliper straddling a brake disc movable into an operative connection with brake pads, and is fastened to a brake anchor plate. A holding clip is releasably fastened to the caliper, on which holding clip springs acting upon exterior edges of the brake pads are supported. The holding clip, by way of its end facing away from the receiving space, rests in a receiving device of the caliper. For fastening the holding clip at its end facing the receiving space on the caliper, a bolt is provided onto which the holding clip is fitted and is held by way of securing devices.

This constructive development now allows a significantly simpler mounting and demounting, respectively, of the holding clip and thus of the brake pads, because the holding clip can be inserted and removed in a less labor-intensive manner.

Also, the production of the disc brake is considerably simpler because the additional manufacture of the threaded bore in the caliper by forming a core bore and cutting a thread can be eliminated.

Furthermore, the bolt can be constructed in one piece with the caliper if the latter is produced as a casting.

However, it is basically also contemplated to provide the bolt with a threaded stem, which will then be screwed into a threaded bore arranged in the caliper, whereby naturally the above-mentioned manufacturing advantage will not occur to the same extent.

However, in any case, it is ensured that the holding clip can be released without problems because weather and/or operational influences will have no effect on an easy releasability of the holding clip.

The holding clip fitted onto the bolt is held by securing devices by which an unintentional releasing of the holding clip will be excluded.

According to an advantageous further development of the invention, the bolt will be provided with a cross bore or a surrounding ring groove, which in both cases are used for the form-locking holding of a securing device.

A securing pin may be inserted into the transverse bore and is secured axially and/or against rotation by means of a connected securing element.

Such a securing element may consist of a clamping plate which is fixedly connected with the securing pin, reaches over the bolt and rests against the side situated opposite the insertion opening.

It is also contemplated to provide the securing pin with a ring which, after the securing pin has been inserted, is placed over the bolt and is supported on this bolt.

In the case of a ring groove provided for securing the holding clip, a snap ring or spring ring may be inserted, which can easily be removed if needed.

In each case, the securing devices are distinguished by a simple construction and handling with respect to the mounting as well as to the demounting.

Additional advantageous further developments are described and claimed herein.

### BRIEF DESCRIPTION OF THE DRAWINGS

Embodiments of the invention will be described in the following by means of the attached drawings.

FIG. 1 is a top view of a disc brake according to the invention;

FIG. 2 is a perspective partial cutout-type view of the disc brake according to FIG. 1;

FIGS. 3 and 4 are partial cutout-type views of different embodiment of the invention, respectively;

FIG. 5 is a partial cross-sectional view of the disk brake according to FIG. 1;

FIGS. 6a and b show two different views of a detail of the invention;

FIGS. 7a and b show two different views of another embodiment of the detail according to FIG. 6;

FIGS. 8a and b show two different views of another embodiment of a detail of the invention;

FIG. 9 is a top view of a detail of the invention;

FIG. 10 also is a top view of another embodiment of a detail of the invention; and

FIGS. 11a and b two different views of another embodiment of a detail.

### DETAILED DESCRIPTION OF THE DRAWINGS

FIG. 1 illustrates a disc brake, particularly for a utility vehicle, including a caliper 1, which has a receiving space 4 for an application device (which is not shown). The caliper straddles a brake disc. Brake pads 3 are movable into an operative connection with brake disc. (FIG. 1 showing only one brake pad 3). The caliper 1 is fastened to a vehicle-side brake anchor plate 1a.

A holding clip 5 is releasably fastened to the caliper 1. This holding clip 5 spans an insertion opening of the caliper 1 for inserting the brake pads and is used as a clamping device for springs 6, which upon the outer edges of the brake pads 3.

By means of its side facing away from the receiving space 4 for the application device, the holding clip 5 is fitted into a receiving device 7 of the caliper 1, while, by means of its other end, it is fitted onto a bolt 8 of the caliper 1 and is held by a securing device.

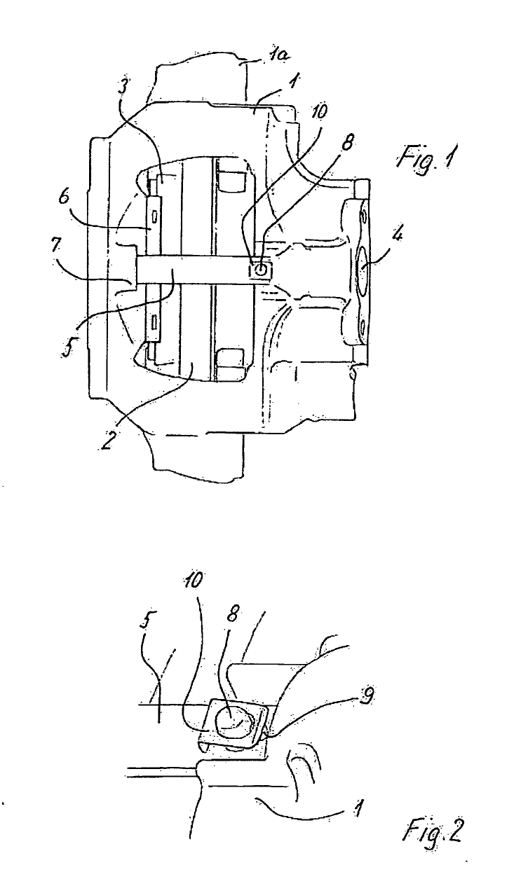

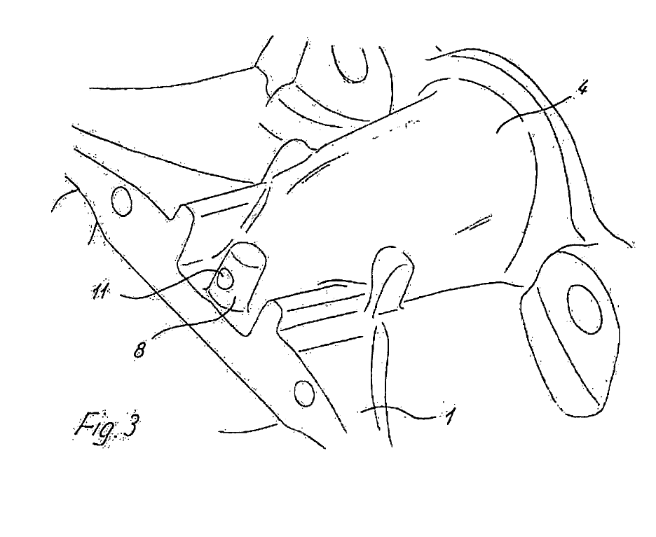

In the embodiment illustrated in FIG. 2, as well as in FIGS. 5 to 7, this securing device consists of a securing pin 9, which is fitted into a transverse bore 11 (FIG. 3) of the bolt 8, as well as of a securing plate 10 fastened to the securing pin 9.

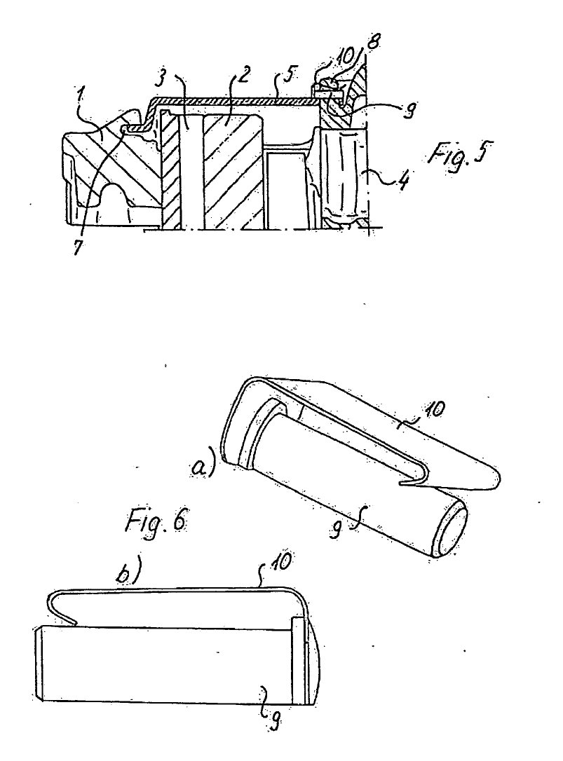

In the embodiment of the securing element illustrated in FIGS. 6a and b, the securing plate 10 is fixed to the head of the securing pin 9 and extends essentially parallel to its longitudinal axis, while the free end is bent.

In the operating position, the securing plate 10 illustrated in FIG. 6a as a perspective view and in FIG. 6b as a lateral view rests against the face of the bolt 8, while the bent end area reaches behind the bolt, so that an axial securing of the securing pin is ensured.

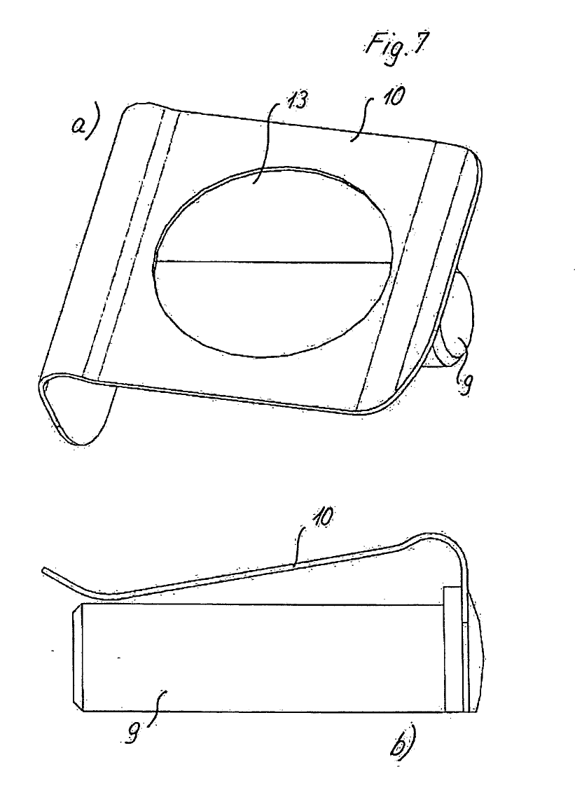

As illustrated in the embodiment of FIG. 7a (also perspectively) and of FIG. 7b (as a lateral view), the securing plate 10 has a passage opening 13, which is penetrated by the bolt 8 and whose diameter corresponds approximately to the diameter of the bolt 8. The operating position of this embodiment is visible in FIGS. 2 and 5. While the bent end area of the securing plate of FIG. 6 points in the direction of the securing pin 9, it has an opposite orientation in the example of FIG. 7.

FIGS. 8 and 11 also show securing devices which can be fitted into the transverse bore 11 of the bolt 8. These also consist of a securing pin 9 and, in the embodiment illustrated in FIG. 8, of a ring 14 connected therewith which, after the insertion of the securing pin 9 into the transverse bore 11, is placed over the bolt 8, so that hereby also an axial securing of the securing pin 9 is ensured.

The securing element according to FIG. 11 is constructed as a securing clip 17 which also has a securing pin 9, which can be fitted into the transverse bore 11 and is adjoined by one spring leg 18, respectively, on the right and the left. This spring leg 18 is provided with a bulge 19 in which the bolt 8 rests under the spring tension of the spring leg 18 after the securing pin 9 is slid into the transverse bore 11. The securing clip 17 may be formed of two mirror-symmetrical wire parts, of which two straight mutually connected legs form the securing pin 9. FIG. 11a is a lateral view and FIG. 11b is a top view of the securing clip 17.

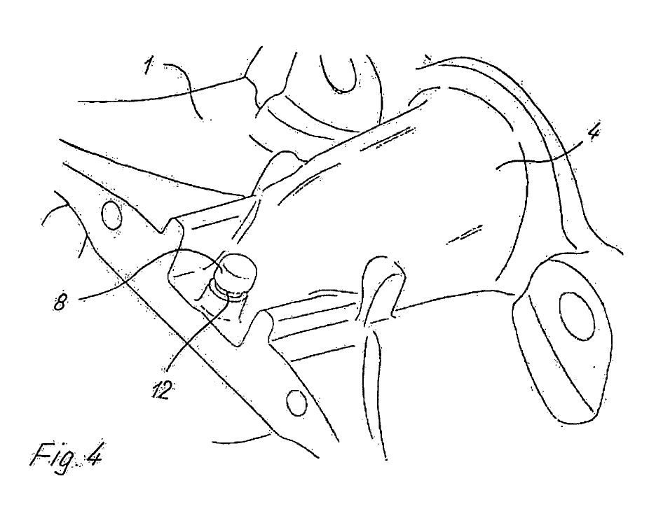

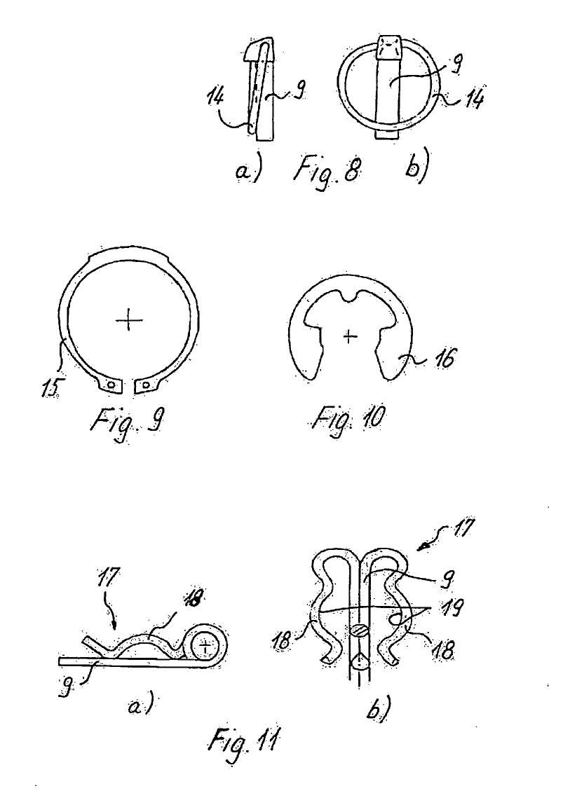

FIGS. 9 and 10 finally show securing elements in the form of a snap ring 15 (FIG. 9) and a securing ring 16 (FIG. 10), respectively. These can be inserted into a ring groove (FIG. 4) of the bolt 8, when the holding clip 5 is fitted on, so that an axial securing of the holding clip 5 on the bolt 8 is ensured.

### TABLE OF REFERENCE NUMBERS

1 caliper
1a brake anchor plate
2 brake disc
3 brake pad
4 receiving space
5 holding clip
6 spring
7 receiving device
8 bolt
9 securing pin
10 securing plate
11 transverse bore
12 ring groove
13 passage opening
14 ring
15 snap ring
16 securing ring
17 securing clip
18 spring leg
19 bulge

1-10. (canceled)

11. A disc brake, comprising:
a caliper having a receiving space for a brake application device, the caliper straddling a brake disc when in use;
brake pads arranged within the caliper;
a holding clip releasably fastened to the caliper;
springs, which are supported by the holding clip and act upon exterior edges of the brake pads;
wherein one end of the holding clip facing away from the receiving space rests in a receiving device of the caliper; and
wherein for fastening the holding clip on the caliper at the end facing the receiving space, a bolt is provided onto which the holding clip is fitted and held via a securing device.

12. The disc brake according to claim 11, wherein the bolt includes a transverse bore for receiving the securing device.

13. The disc brake according to claim 11, wherein the bolt includes a ring groove for receiving the securing device.

14. The disc brake according to claim 11, wherein the securing device includes a securing pin, which securing pin is fitted into a transverse bore of the bolt.

15. The disc brake according to claim 14, wherein a securing element is fixedly connected with the securing pin, the securing element being held on the bolt in an axially secured manner to secure the securing pin in the transverse bore.

16. The disc brake according to claim 15, wherein the securing element is a securing plate, which is fastened to a head of the securing pin and covers a face of the bolt, a bent free end of the securing plate resting on a lateral wall of the bolt.

17. The disc brake according to claim 16, wherein the securing plate includes a passage opening pentratable by the bolt.

18. The disc brake according to claim 11, wherein the securing device is a securing clip having a securing pin and two spring legs which rest on an exterior side of the bolt under spring tension.

19. The disc brake according to claim 15, wherein a ring connected with the securing pin forms the securing element, said ring being swiveled over the bolt after the securing pin is inserted in the transverse bore.

20. The disc brake according to claim 11, wherein the securing device is a snap ring which engages in a ring groove on the bolt.

21. A caliper for a disc brake in which brake pads are applied against a brake disc, the caliper comprising:
a housing having a first section configured to house a brake application device and a second section configured to straddle the brake disc;
a receiving unit configured to receive one end of a holding clip for the brake pads, the receiving unit being formed on an out bored section of the caliper that straddles the brake disc; and
a post formed on the section of the caliper that houses the brake application unit, the post being configured to secure the other end of the holding clip.

22. The caliper according to claim 21, wherein the post includes a transverse bore operatively configured to receive a securing pin of the holding clip.

23. The caliper according to claim 21, wherein the post includes a ring groove operatively configured to receive a snap ring formed at the end of the holding clip.
